(19) United States
(12) Patent Application Publication
(10) Pub. No.: US 2002/0076140 A1
(43) Pub. Date: Jun. 20, 2002

(54) MEMS optical switch with pneumatic actuation

(75) Inventor: Boris Kobrin, San Francisco, CA (US)

Correspondence Address: JOSHUA D. ISENBERG, 204 CASTRO LANE, FREMONT, CA, 94539, US

(73) Assignee: Onix Microsystems, Inc., Richmond, CA

(21) Appl. No.: 09/992,531

(22) Filed: Nov. 6, 2001

Related U.S. Application Data
(60) Provisional application No. 60/255,734, filed on Dec. 14, 2000.

(51) Int. Cl. G02B 6/35

(52) U.S. Cl. 385/18

(57) ABSTRACT

A gas pulse is used to actuate the movable part (e.g. a rotatable mirror) of a MEMS device. The MEMS device generally comprises a substrate and one or more movable elements coupled to the substrate and means for pneumatic actuation of at least one of the one or more movable elements. The MEMS device may be in the form of an NXN optical crossbar switch. Pneumatic actuation eliminates the need for magnetic pads and electromagnets along with the disadvantages associated with MEMS devices having these components. Such pneumatic actuation may be incorporated into a MEMS optical switch having a substrate and one or more rotatable mirrors coupled for rotation with respect to the substrate.

### CROSS-REFERENCE TO A RELATED APPLICATION

This application is based on and claims priority from Provisional application No. 60/255,734 filed Dec. 14, 2000, the entire disclosure of which is incorporated herein by reference.

### FIELD OF THE INVENTION

This invention relates generally to microelectromechanical systems (MEMS). More particularly, it relates to actuation of MEMS devices.

### BACKGROUND ART

Microelectromechanical systems (MEMS) are miniature mechanical devices manufactured using the techniques developed by the semiconductor industry for integrated circuit fabrication. Previous patents and publications have described fiber-optic switches that employ moveable micromirrors that move between two positions. Some of the prior art also employs electrostatic clamping of these mirrors at one or more of its two positions. For example, FIGS. 1 and 2 depict an optical crossbar switch 100 having a series of moveable mirrors 102 moveably coupled to a substrate 104. The mirrors 102 may be magnetically actuated as is known in the art. The mirrors 102 can be electrostatically clamped either in the horizontal position to the substrate 104 or in the vertical position to the sidewalls of a separate chip. In the vertical position, the mirrors 102 deflect light from an input fiber 106 into an output fiber 108. The mirrors 102 may be enclosed by a package 107.

The design, fabrication, and operation of magnetically actuated micromirrors with electrostatic clamping in dual positions for fiber-optic switching applications are described, for example in B. Behin, K. Lau, R. Muller “Magnetically Actuated Micromirrors for Fiber-Optic Switching”, Solid-State and Actuator Workshop, Hilton Head Island, S.C., Jun. 8-11, 1998 (p. 273-276) which is incorporated herein by reference. Such mirrors, shown in FIGS. 1 and 2, are typically actuated by an off-chip electromagnet and can be individually addressed by electrostatic clamping either to the substrate surface or to the vertically etched sidewalls formed on a top-mounted (110)-silicon chip. The magnetic actuation is used to move the mirrors between their rest position parallel to the substrate and a position nearly parallel to the vertical sidewalls of the top-mounted chip. The mirror can be clamped in the horizontal or vertical position by application of an electrostatic field between the mirror and the substrate or vertical sidewall, respectively. The electrostatic field holds the mirror in that position regardless of whether the magnetic field is on or off.

This technology has many drawbacks:

1. For example, magnetic actuation often requires creating magnetic material pads 110 (pads) on the movable mirrors 102. This is usually achieved using a thick photoresist mask pattern and electroplating of a thick (about 10 um) magnetic layer through the photoresist mask. The pads 110 limit the area of the mirror 102 that is available for deflecting optical signals.

2. Magnetic actuation also often requires a quite bulky electromagnet 112 attached outside a device package. The electromagnet 112 increases the weight of the switch 100. Operation of the electromagnet also consumes a significant amount of power.

3. The movable parts (e.g., mirrors 102) are usually connected to the substrate 104 or other support structure by a thin hinge. Thick magnetic pads created on the movable part (e.g., mirrors 102) increase the probability that the hinges will break during operation and handling of the switch 100.

4. Magnetic pads 110 placed on the movable part (mirror 102) consume surface area of the device, which decrease a level of integration (or scale of device).

There is a need, therefore, for improved MEMS actuation that overcomes the above difficulties.

### SUMMARY

These disadvantage associated with the prior art are overcome by the present invention of using a gas pulse to actuate the movable part (e.g. a rotatable mirror) of a MEMS device. The MEMS device generally comprises a substrate and one or more movable elements coupled to the substrate and means for pneumatic actuation of at least one of the one or more movable elements. The MEMS device may be in the form of an NXN optical crossbar switch. Pneumatic actuation eliminates the need for magnetic pads and electromagnets along with the disadvantages associated with MEMS devices having these components. Such pneumatic actuation may be incorporated into a MEMS optical switch having a substrate and one or more rotatable mirrors coupled for rotation with respect to the substrate.

### BRIEF DESCRIPTION OF THE FIGURES

FIG. 1 depicts an NXN MEMS optical crossbar switch according to the prior art;

FIG. 2 depicts a simplified cross-sectional schematic diagram of a MEMS optical switch with magnetic actuation according to the prior art;

FIG. 3 depicts a simplified cross-sectional schematic diagram of a MEMS device with pneumatic actuation and common gas pulse from the backside of a substrate according to an embodiment of the present invention;

FIG. 4 depicts a simplified cross-sectional schematic diagram of a MEMS device with pneumatic actuation using a common gas pulse from above a substrate according to an embodiment of the present invention;

FIG. 5 depicts a simplified cross-sectional schematic diagram of a MEMS device with individual pneumatic actuation of each movable element using multiple electro-pneumatic control valves according to an embodiment of the present invention;

FIG. 6 depicts a simplified cross-sectional schematic diagram of a MEMS device with pneumatic actuation of each movable element using MEMS pneumatic control valves according to an embodiment of the present invention;

FIG. 7 depicts a simplified cross-sectional schematic diagram of a MEMS device with pneumatic actuation of each movable element using Knudsen compressors according to an embodiment of the present invention;

FIG. 8 depicts a simplified cross-sectional schematic diagram of a MEMS device with pneumatic actuation of elements using a micro-pump according to an embodiment of the present invention;

### DETAILED DESCRIPTION

Although the following detailed description contains many specifics for the purposes of illustration, anyone of ordinary skill in the art will appreciate that many variations and alterations to the following details are within the scope of the invention. Accordingly, the following preferred embodiment of the invention is set forth without any loss of generality to, and without imposing limitations upon, the claimed invention. Like reference numbers are used for like elements throughout.

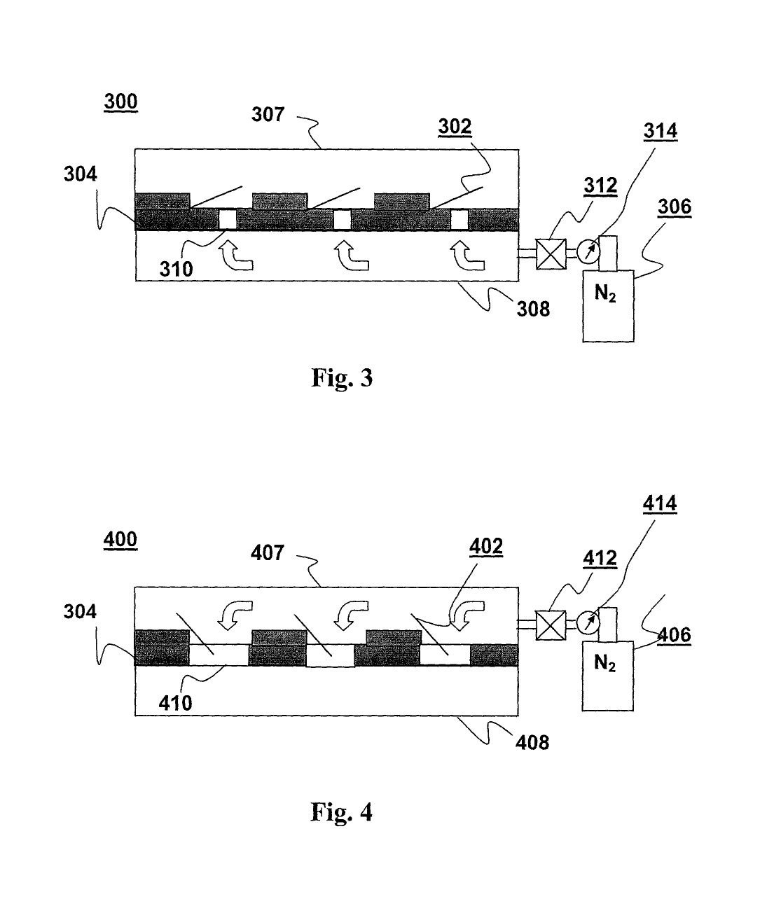

FIG. 3 depicts an embodiment of a MEMS device 300 with pneumatic actuation and common gas pulse from the backside of a substrate. The device generally comprises a substrate 304 with one or more movable elements 302, such as mirrors, mounted for rotation with respect to the substrate 304. Alternatively, the movable elements 302 may translate, e.g. vertically or horizontally. Gas (preferably nitrogen, although other inert gases will also work) can be supplied from a source 306 to a device package 307 and directed to a chamber 308 under the movable elements 302 through holes 310 in the backside of the substrate 304. In this embodiment a micro valve 312 and gas regulator 314 connected between the gas source 306 and the chamber 308 control gas pulse duration and flow. A filter may optionally be included to remove particles from the gas.

Different layouts of the movable elements may require a different direction of gas flow. For example FIG. 4 depicts an embodiment of a MEMS device 400 in which a gas source 406, microvalve 412 and regulator 414 feed a gas pulse to a package 407 located above a substrate 404 containing moveable elements 402. The gas may then be exhausted into an exhaust chamber 408 through holes 410 located proximate each movable element 402.

In the embodiments depicted in FIGS. 3-4 the gas pulse rotates all the mirrors at the same time. Individual mirrors may be held in place in an “on” position using conventional electrostatic clamping. The movable elements may further include torsional flexures that rotate the elements back to an “off” position in the absence of an actuating force, such as the gas pulse. In this fashion individual movable elements may be switched from the “on” position to the “off” position using a combination pneumatic actuation and electrostatic clamping.

In many MEMS applications it is desirable to actuate only selected movable elements in an array without actuating others. Several embodiments of the present invention may be implemented to achieve this.

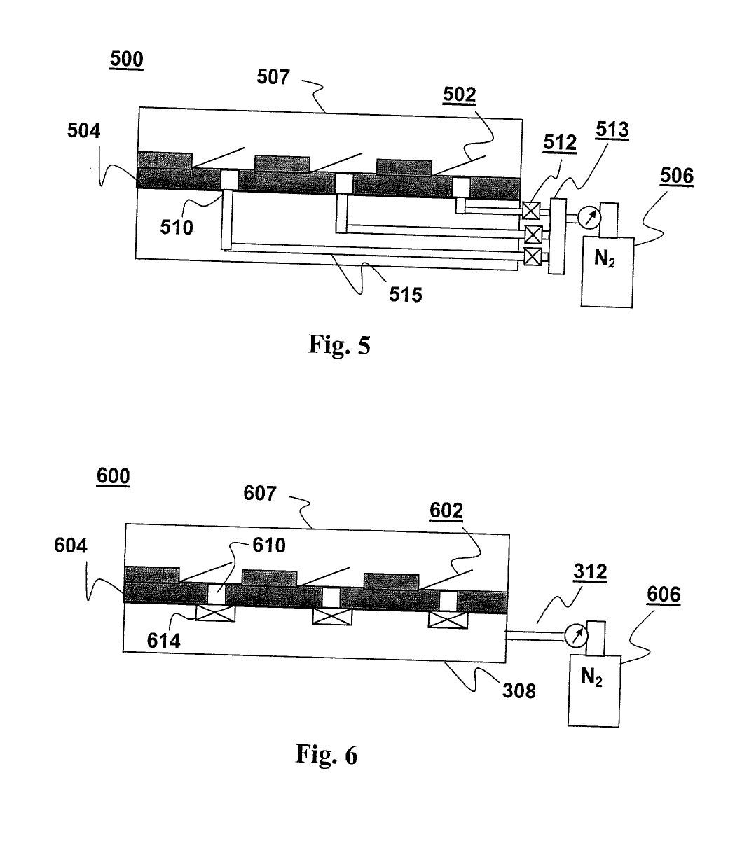

For example, FIG. 5 depicts a MEMS device 500 that uses multiple electro-pneumatic control valves 512 to allow separate actuation of each of several movable elements 502 (or rows or columns of such elements) moveably coupled to a substrate 504. Thus each element 502 may be moved only when it needs to be switched between two fixed positions. This reduces number of actuations for each movable element 502 and leads to longer lifetime of the device 500. The control valves 512 may be coupled to a manifold 513 that communicates with a gas source 506. A device package 507 may be attached to the substrate to enclose the moveable elements 502. Each control valve 512 may be coupled to a corresponding hole 510 in the substrate 504 through a dedicated channel 515.

Alternatively, as shown in FIG. 6, a MEMS device 600 may include individual arrayable MEMS pneumatic control valves 614 may be used to feed gas from a source 606 to each of several movable elements 602 moveably coupled to a substrate 604. A device package 607 may be attached to the substrate to enclose the moveable elements 602. Arrays of such valves are described in detail, for example, in “Batch Fabrication of Pneumatic Valve Arrays by Combining MEMS with Printed Circuit Board Technology,” Patrick Cheung, Andrew Berlin, David Biegelsen, Warren B. Jackson, DSC-Vol 62/HTD-Vol 354, Microelectromechanical Systems (MEMS) ASME 1997. Such valves may operate in a 1-20 ms range.

Alternatively, as shown in FIG. 7, a MEMS device 700 may include one or more movable elements 702, moveably coupled to a substrate 704 that may be actuated by an array of Knudsen Compressor devices 716. A device package 707 may be attached to the substrate to enclose the moveable elements 702. The operation of Knudsen compressors is based on thermal transpiration. In a typical Knudsen compressor two volumes of gas are separated by a thin membrane having many holes. Each of the holes is characterized by dimensions that are small compared to the mean free paths of the gas. If the two volumes are maintained at temperatures T₁ and T₂, but are otherwise undisturbed, the equilibrium pressures p₁ and p₂ of the two volumes are related by p₁/p₂=(T₁/T₂)^{½.}

Each Knudsen compressor 716 in the array can be aligned and attached to the backside of the substrate 704 proximate a corresponding movable element 702 to provide a gas pulse on demand to actuate each movable element 702 individually. A device package 707 may be attached to the substrate to enclose the moveable elements 702. MEMS type Knudsen compressors are described in detail, for example, in “The Knudsen Compressor as a Micro and Macroscale Vacuum Pump Without Moving Parts or Fluids,” S. E. Vargo, E. P. Muntz and G. R. Shiflett, W. C. Tang.

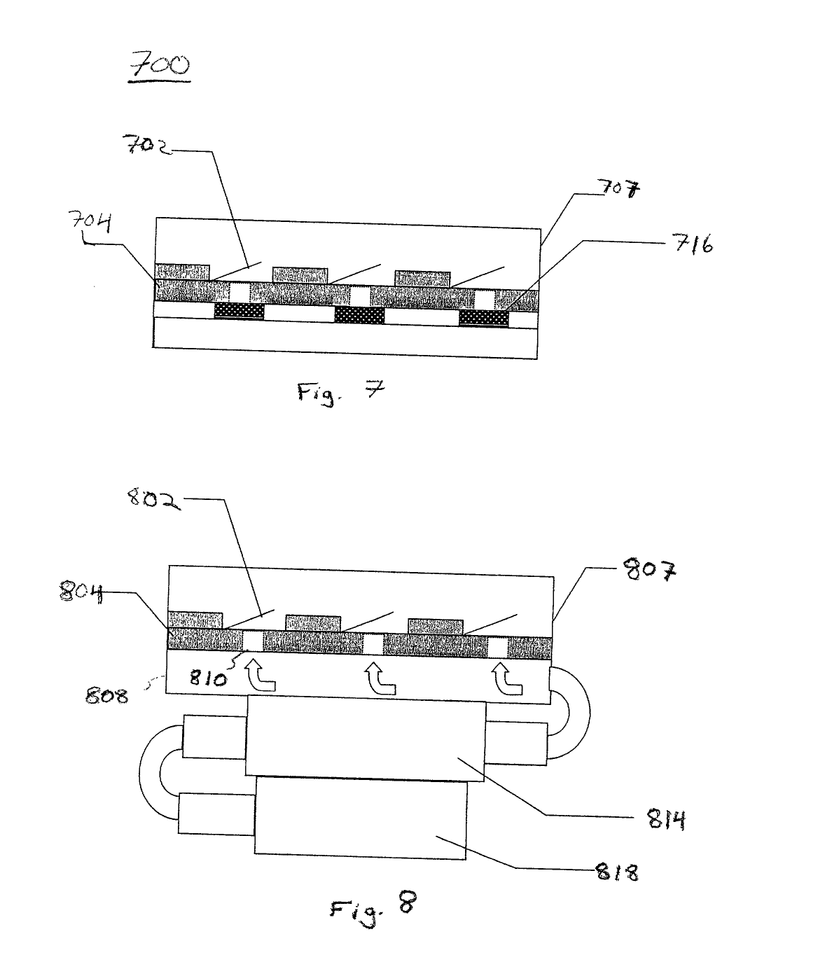

Instead of cylinder gas supply one can alternatively use a micro pump (compressor), which generates a positive pressure. FIG. 8 depicts an example of a MEMS device 800 employing a micropump 818 coupled to a chamber beneath a substrate 804. Moveable elements 802 are moveably coupled to the substrate 804. Holes 810 disposed proximate the moveable elements 802. A device package 807 may be attached to the substrate to enclose the moveable elements 802. The micropump 818 actuates the moveable elements 802, e.g., by providing a gas pulse to the holes 810 via a chamber 808 disposed below the substrate 804. A microvalve 814 may be coupled between chamber and the micropump 818 to control the flow of gas. Examples of suitable micro pumps include “AAA” series micro-air pump of Sensidyne, Inc., of Clearwater, Fla. (6 psi, 98% air filtration), or the NMP05 micro-diaphragm pump and compressor of KNF Neuberger, Inc of Trenton, N.J. (6 psi, 20 gr. Weight, 30×20×17 mm³ volume).

Examples of suitable micro valves 814, include control valves of the Lee Company of Westbrook Conn., (2.5 ms response time, 12 mm dia×30 mm, power consumption—780 mW).

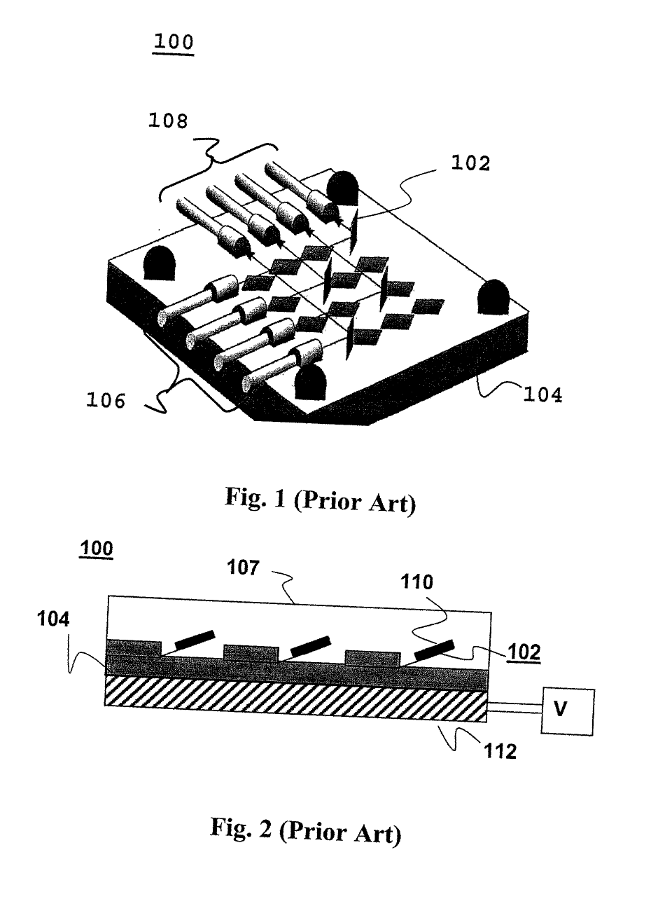

Any of the embodiments of pneumatic actuation means depicted in FIGS. 3-8 may be incorporated into a MEMS optical switch, such as an NXN crossbar switch of the type shown in FIG. 1. Such a switch typically includes a substrate and a plurality of rotatable mirrors, mounted for rotation with respect to the substrate. Advantages of such a MEMS optical switch with pneumatic actuation over similar switches with magnetic actuation are as follows:

1. The moveable elements (mirrors) do not require a magnetic pad for actuation. The manufacturing is therefore simpler due to elimination of the electroplating process used to deposit the magnetic pads.

2. The overall weight of the switch is reduced due to elimination of outside electromagnet.

3. The overall power consumption of the switch is reduced due to elimination of electromagnets normally used for magnetic actuation.

4. The size of the mirror elements may be made smaller and the scalability of the switch is enhanced since more elements may be incorporated onto the same footprint of the MEMS device due to elimination of the magnet pads.

5. Eliminating the heavy magnetic pads enhances the reliability of the switch due to reduced overall weight of the movable parts suspended on the hinges.

6. The absence of magnetic materials on a mirror makes the optical switch insensitive to external electromagnetic fields.

7. Using nitrogen gas feed for mirror actuation improves reliability of the switch by eliminating external moisture penetration into the package, which can lead to stiction problems.

In accordance with the foregoing, low-cost, high yield scalable MEMS devices and switches may be provided without the disadvantages attendant to magnetic actuation. It will be clear to one skilled in the art that the above embodiment may be altered in many ways without departing from the scope of the invention. Therefore, the scope of the present invention should be determined not with reference to the above description but should, instead, be determined with reference to the appended claims, along with their full scope of equivalents. The appended claims are not to be interpreted as including means-plus-function limitations, unless such a limitation is explicitly recited in a given claim using the phrase “means for.”

What is claimed is:

4. A MEMS device comprising:
a) a substrate;
b) one or more movable elements coupled to the substrate for movement with respect to the substrate; and
c) means for pneumatic actuation of at least one of the one or more movable elements.

5. The device of claim 1 wherein the means for pneumatic actuation delivers a gas pulse to the one or more movable elements through a venting hole in a backside of the substrate.

6. The device of claim 1 wherein the means for pneumatic actuation delivers a gas pulse to a package volume above the substrate.

4. The device of claim 1, wherein the substrate includes one or more venting holes coupled to the means for pneumatic actuation, wherein each venting hole is in independent communication with a different one of the one or more moveable elements, whereby the means for pneumatic actuation delivers a gas pulse to each of the one or more movable elements independently through the venting holes.

5. The device of claim 1 wherein the means for pneumatic actuation includes one or more MEMS pneumatic control valves.

6. The device of claim 1 wherein the means for pneumatic actuation includes one or more Knudsen compressors.

7. A MEMS optical switch, comprising:
a) a substrate;
b) one or more rotatable mirrors coupled for rotation with respect to the substrate; and
c) means for pneumatic actuation of the rotatable mirrors.

8. The optical switch of claim 7 wherein the means for pneumatic actuation delivers a gas pulse to the one or more movable elements through a venting hole in a backside of the substrate.

9. The optical switch of claim 7 wherein the means for pneumatic actuation delivers a gas pulse to a package volume above the substrate.

10. The optical switch of claim 7, wherein the substrate includes one or more venting holes coupled to the means for pneumatic actuation, wherein each venting hole is in independent communication with a different one of the one or more moveable elements, whereby the means for pneumatic actuation delivers a gas pulse to each of the one or more movable elements independently through the venting holes.

11. The optical switch of claim 7 wherein the means for pneumatic actuation includes one or more MEMS pneumatic control valves.

12. The optical switch of claim 7 wherein the means for pneumatic actuation includes one or more Knudsen compressors.
